(19) United States
(12) Patent Application Publication
(10) Pub. No.: US 2025/0329489 A1
(43) Pub. Date: Oct. 23, 2025

(54) PLANAR ELECTRICAL TRANSFORMER AND ASSEMBLY

(71) Applicant: VALEO ELECTRIFICATION, Cergy Pontoise (FR)

(72) Inventors: Rudy BATTISTELLA, Cergy (FR); Aurélien POUILLY, Cergy Pontoise (FR); Baptiste PARIGOT, Cergy Pontoise (FR); Massourang DIALLO, Cergy Pontoise (FR); Wendell DA CUNHA ALVES, Cergy Pontoise (FR)

(73) Assignee: VALEO ELECTRIFICATION, Cergy Pontoise (FR)

(21) Appl. No.: 18/868,422

(22) PCT Filed: May 12, 2023
(86) PCT No.: PCT/EP2023/062833

§ 371 Date: Nov. 22, 2024

(30) Foreign Application Priority Data
May 30, 2022 (FR) 2205123

(51) Int. Cl. H01F 27/28; H01F 41/04

(52) U.S. Cl. CPC H01F 27/2804; H01F 41/041; H01F 2027/2809

(57) ABSTRACT

A planar electrical assembly includes a substrate, in particular formed from sheets of prepreg. The substrate includes, incorporated into the mass of the substrate, at least one primary electrically conductive winding, in a first layer of the substrate, forming at least part of a primary circuit for an electrical transformer. At least one secondary electrically conductive winding is provided in a second layer of the substrate superimposed on the first layer and forming at least part of a secondary circuit for the electrical transformer.

The present invention relates to the field of electrical transformers. More specifically, the present invention relates to a planar electrical assembly for forming a planar electrical transformer.

This electrical transformer belongs for example to an electric circuit carried on board an electric or hybrid vehicle, this circuit being commonly referred to as the “on-board network”.

This transformer makes it possible for example to pass from a voltage of 12 V or 48 V to a voltage higher than 300 V, for example of 400 V or 800 V, and vice versa. As an alternative, this transformer is associated with an inverter/rectifier so that an electrical-energy storage unit belonging to the vehicle can be charged from an electrical network external to the vehicle, this electrical-energy storage unit having, for example, a voltage of 48 V or more, for example a voltage higher than 300 V, such as a voltage of 400 V, 800 V, or more.

The present invention thus relates to the manufacture of a planar electrical transformer, which is to say one comprising a planar monolithic electrical assembly to which a ferromagnetic core is added.

One known series of problems lies in the need to produce such electrical transformers in a form that is compact while still taking into consideration the associated constraints regarding heating and cooling.

The most conventional known structure for an electrical transformer consists in a winding of turns of copper wire around a ferromagnetic core, generally made of ferrite. However, this type of coil is very bulky because the winding extends, spatially, around the ferromagnetic core, as a volume, or in other words substantially uniformly in all three dimensions of space.

According to the prior art, it is in fact known practice to produce coils consisting of thin layers of electrically conductive material, notably copper, these being superposed and separated by thin electrically insulating layers. Said layers of electrically conductive material are brought into mechanical and electrical contact with one another, notably by soldering, to form a spiral able to act as a coil. In this way, substantially planar coils of small spatial bulk are obtained.

However, in order to form an electrical transformer, it is necessary to have a primary circuit and a secondary circuit which are magnetically coupled via a ferromagnetic core. Thus, in order to produce an electrical transformer of reduced bulk, even bearing in mind the above-mentioned technology relating to substantially planar coils, in the prior art, a printed circuit board, otherwise known as a PCB, is produced, this board being formed of a substrate, for example made of a preimpregnated material, incorporating at least one electrically conductive winding forming a secondary or primary circuit of an electrical transformer. To this PCB there are then added at least another winding forming a primary or secondary circuit, respectively, and also a ferromagnetic core, in order to produce a complete electrical transformer. Thus, there is added, to the PCB that incorporates a secondary or primary winding, another conductive winding, generally made of copper, which is brazed or soldered or even adhesively bonded to said PCB.

There is therefore still a need for a less bulky planar electrical transformer, and for a corresponding method of manufacture. The object of the invention is, in general, to promote the industrial-scale manufacture of planar electrical transformers.

More specifically, the invention relates to a planar electrical assembly comprising a substrate, in particular formed from sheets of prepreg. The planar electrical assembly comprises, incorporated into the mass of the substrate:
at least one primary electrically conductive winding, in a first layer of the substrate, and forming at least part of a primary circuit for an electrical transformer, and, on the other hand
at least one secondary electrically conductive winding, in a second layer of the substrate which is superposed on the first layer, and forming at least part of a secondary circuit for the electrical transformer.

Notably, the secondary electrically conductive windings are held in the planar electrical assembly solely by the material of said substrate, in particular solely by the assembling of the sheets of prepreg that form the material of said substrate. A sheet of prepreg is an expression used as a synonym for a sheet of preimpregnated material.

According to one embodiment, the electrical assembly according to the invention comprises a plurality of first layers and a plurality of second layers stacked alternately. According to one embodiment, said at least one primary electrically conductive winding is in the shape of a spiral.

According to one embodiment, said at least one secondary electrically conductive winding has an undulating shape in the plane of the second layer. According to one embodiment, the planar electrical assembly comprises a plurality of secondary electrically conductive windings connected in parallel to common secondary electrical connection terminals.

According to one embodiment, the substrate is obtained from a stack of several sheets of prepreg thermoset together.

According to a variant:
the first layer of the substrate is obtained from at least a first sheet of prepreg with the at least one primary electrically conductive winding etched onto one of the faces thereof, and
the second layer of the substrate is obtained by adding the at least one secondary electrically conductive winding to a prepreg face of the first layer and by covering said secondary electrically conductive winding with a second sheet of prepreg.

In particular, in the context of the present application, a “prepreg face” refers to an outer surface of a layer, said surface being formed wholly of prepreg.

According to a sub-variant:
the first layer of the substrate is obtained from the first sheet of prepreg with a respective primary electrically conductive winding etched onto each of the faces thereof, a third sheet of prepreg then covering one face of said first sheet of prepreg;
the second layer of the substrate is obtained by adding the at least one secondary electrically conductive winding to the free face of the third sheet of prepreg and by covering it with said second sheet of prepreg.

According to one embodiment:
the primary electrically conductive winding is formed of an electrical track, notably of a thickness less than or equal to 0.25 mm; and
the secondary electrically conductive winding is formed of an electrically conductive leaf (or even of a rigid conductor such as an electrically conductive bar) notably of a thickness greater than or equal to 0.4 mm and/or less than 2 mm.

In at least a first layer, the primary electrically conductive winding may be an electrical track defining two spirals connected in series. These two spirals may have the same shape and be symmetrical with respect to one another about an axis intersecting the substrate. This axis then intersects the series connection between the two spirals.

From one end of one spiral to the other, including at the series connection between the two spirals, the electrical track defining the primary electrically conductive winding may maintain the same width.

Each spiral may at its free end have a primary connection terminal, this primary terminal enabling the primary electrically conductive winding to be connected to the outside. This connection is, for example, to the high-voltage part of the on-board network.

From one spiral to the other, the same number of turns may be present, for example between three and ten turns, for example five turns.

When a plurality of first layers are present, all or some of these first layers may comprise an electrical track defining two spirals connected in series, and these different spirals-in-series may be connected in parallel, from one first layer to the other.

In at least one second layer, the secondary electrical winding may be an electrically conductive leaf having an undulating shape.

In an axis of stacking along which the first layer(s) are stacked with the second layer(s), the electrically conductive leaf and the electrical track defining two spirals connected in series may at least partially overlap. Such an arrangement makes it possible to further enhance the induction effect.

The electrically conductive leaf may have the shape of a W when viewed along this axis of stacking.

The leaf defines for example two there-and-back undulations, each there-and-back undulation comprising two straight parts connected to one another by a bent part.

The first there-and-back undulation may extend between a first secondary connection terminal that connects the secondary electrically conductive winding to the outside, and a second secondary connection terminal that connects this secondary electrically conductive winding to the outside. This connection is, for example, to the low-voltage part of the on-board network.

The second there-and-back undulation may extend between the aforementioned second secondary connection terminal and a third secondary connection terminal that connects the secondary electrically conductive winding to the outside. The second secondary connection terminal may make it possible to define an intermediate connection in the secondary electrical winding, for example at a midpoint. As an alternative, only two secondary terminals may be provided: the first and the third.

When the primary and secondary terminals are present, the primary terminals may project from the one same first side of the substrate while the secondary terminals may project from the one same second side of the substrate. These first and second sides of the substrate are for example opposite sides. The high-voltage part and the low-voltage part of the transformer can thus be separated from one another in order better to conform to different electrical isolation constraints.

Each straight part of the electrically conductive leaf may be superposed with the straight part of a spiral of the electrical track in a first layer along the axis of stacking. This then improves coupling.

The cumulative width of the various turns that make up a straight part of a spiral may be substantially equal to the width of the straight part of the electrically conductive leaf superposed therewith.

When a plurality of second layers are present, all or some of these second layers may comprise an electrically conductive leaf as described hereinabove. These various leaves may be connected in parallel, from one second layer to another.

The aforementioned overlap may be present in respect of all of the first layers and all of the second layers.

The invention also relates to an electrical transformer comprising an electrical assembly according to the invention, as well as a ferromagnetic core added to said substrate so as to magnetically couple the primary electrically conductive windings with the secondary electrically conductive windings. In particular, the ferromagnetic core is added into a through-opening in the planar electrical assembly.

In particular, the planar electrical assembly is pressed intimately against a heatsink plate or against a fluid-cooled cooling plate, so that one face of the ferromagnetic core is pressed intimately against the heatsink plate or against the fluid-cooled cooling plate so as to cool the ferromagnetic core.

The invention moreover relates to a method for manufacturing an electrical assembly comprising a primary circuit and a secondary circuit, said method comprising the following steps:
a first layer comprising a first sheet of prepreg is formed and a primary electrically conductive winding is etched onto one of the faces of said sheet, said primary electrically conductive winding being intended to form at least part of a primary circuit of an electrical transformer;
a monolithic electrical conductor, referred to as secondary electrically conductive winding, is sourced;
the secondary electrically conductive winding is set down on a prepreg face of the first layer, said secondary electrically conductive winding being intended to form at least part of a secondary circuit of the electrical transformer;
a second sheet of prepreg is set down on top;
the entity consisting of the sheets of prepreg and the primary and secondary electrically conductive windings is pressed and heated so as to assemble said sheets together and form the electrical assembly comprising the stack of primary and secondary electrically conductive windings.

All or part of the foregoing, which has been described with reference to the planar electrical assembly also applies to the method, notably the structure of the primary electrically conductive winding with the electrical track defining two spirals connected in series, and the structure of the secondary electrically conductive winding which has an undulating shape.

According to one implementation of the method according to the invention:
as part of the forming of the first layer of the substrate, a respective primary electrically conductive winding is etched onto the two faces of the first sheet of prepreg,
then a third sheet of prepreg is set down on one face of the first sheet of prepreg,
after which the secondary electrically conductive winding is set down on the free face of said third sheet of prepreg.

According to one embodiment, primary electrical connectors electrically connected to the primary electrically conductive windings are then incorporated into the substrate.

According to one embodiment, each secondary electrical conductor has at least an end portion extending beyond the superposition of said substrates, in the continuation of the plane of the second layer, to form at least one connection terminal of the secondary circuit.

According to one embodiment, a ferromagnetic core is added to the substrate so as to magnetically couple the primary electrically conductive windings with the secondary electrically conductive windings and form an electrical transformer.

The invention will be better understood from reading the following description, given solely by way of example and made with reference to the attached drawings provided by way of nonlimiting examples, in which drawings identical references are assigned to objects that are similar and in which:

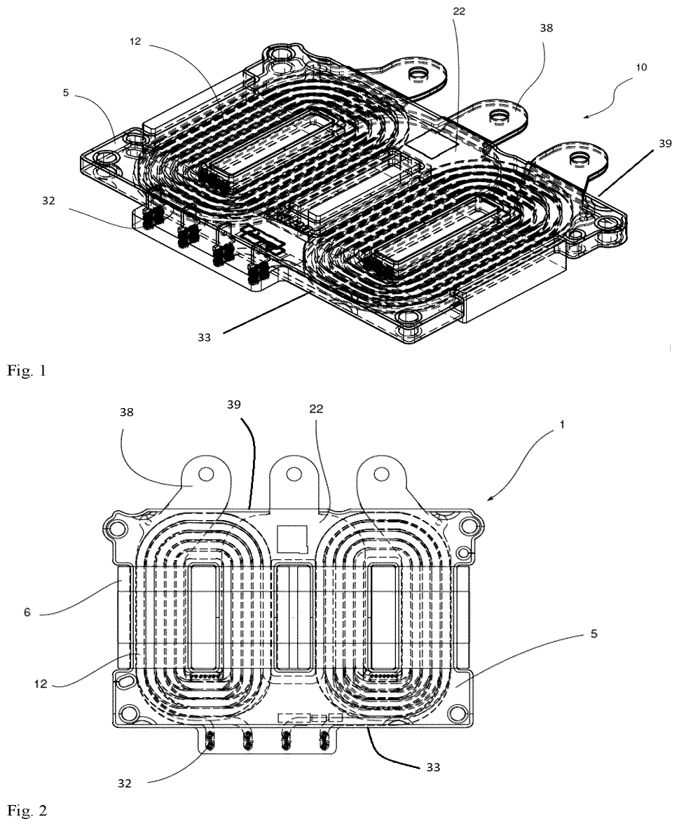

FIG. 1 shows an example of an electrical assembly according to the invention, in perspective;

FIG. 2 depicts a view from above of the same example of an electrical assembly according to the invention;

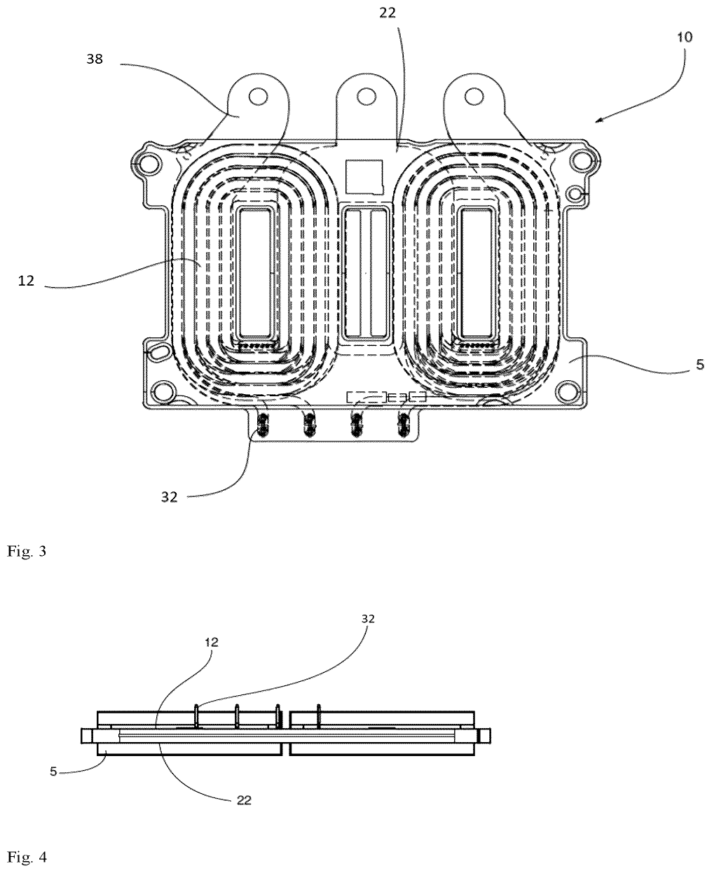

FIG. 3 depicts a view from above of a corresponding electrical transformer, namely one with an added ferromagnetic core;

FIG. 4 depicts a face-on view of the same example of an electrical transformer according to the invention;

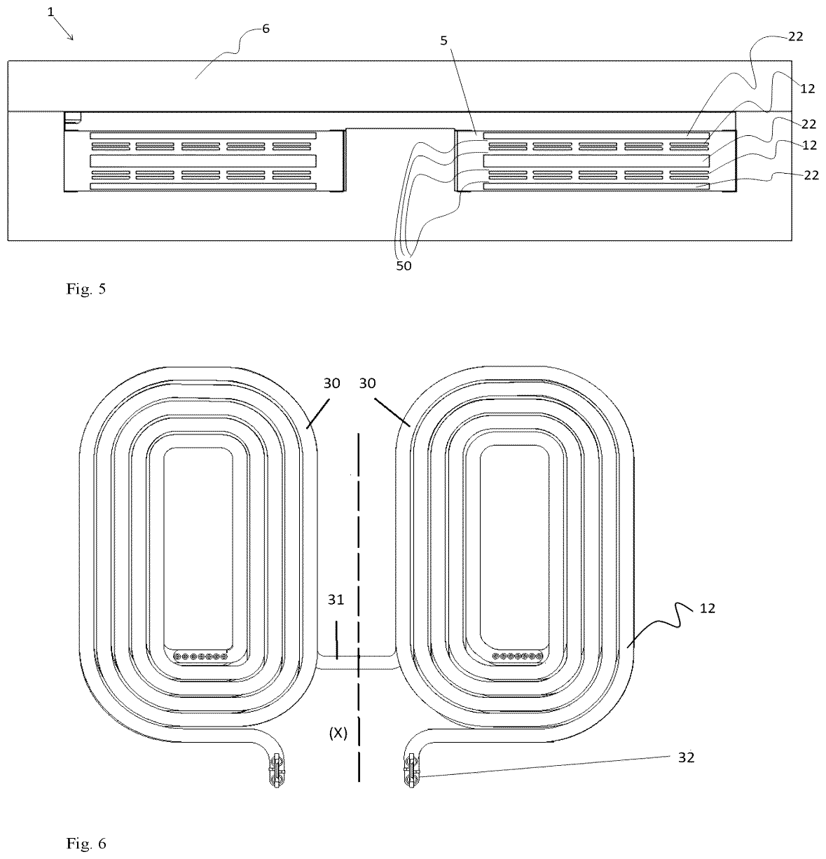

FIG. 5 is a diagram of a multilayer architecture of an electrical transformer according to the invention;

FIG. 6 depicts an example of a primary electrically conductive winding;

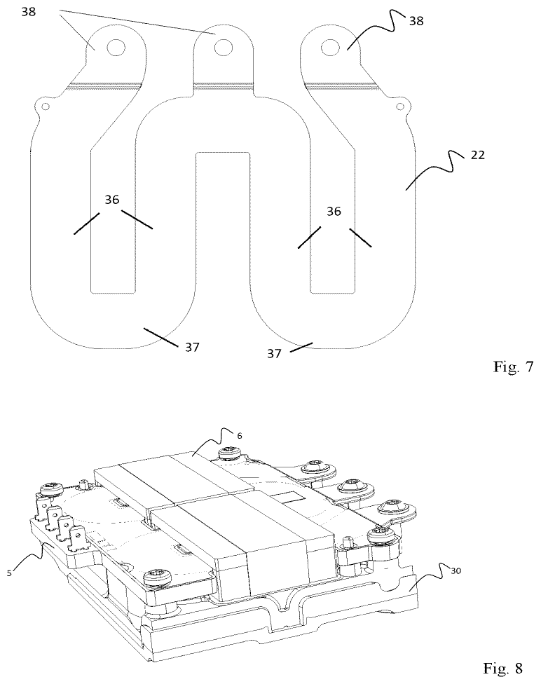

FIG. 7 depicts an example of a secondary electrically conductive winding;

FIG. 8 depicts a perspective view of the electrical transformer equipped with a heatsink plate.

It should be noted that the figures set out the invention in detail so as to enable the invention to be implemented, it of course being possible for said figures to be used to better define the invention if necessary.

The invention relates, in substance, to the production of a planar electrical transformer that is monolithic with the exception of the ferromagnetic core alone, which is added.

The invention therefore lies first of all in a substrate incorporating, in the mass of the substrate, a stacked structure of at least a first layer incorporating a primary-circuit electrically conductive winding and at least one second layer incorporating a secondary-circuit electrically conductive winding. The substrate is obtained from preimpregnated material, otherwise referred to as a prepreg, impregnated for example with epoxy resin. In particular, said substrate therefore forms a printed circuit board, or in other words a PCB.

The invention also covers a corresponding method of manufacture.

With reference to FIGS. 1 to 7, the electrical transformer 1 according to one example of the invention thus comprises, firstly, a monolithic electrical assembly 10, notably one incorporated into a PCB.

The assembly comprises a substrate 5, notably obtained from a prepreg. The substrate comprises a second layer into which there is incorporated a secondary conductive winding 22, namely one intended to form at least part of an electrical transformer secondary circuit.

On top of this secondary conductive winding 22, a thickness of substrate 50, notably obtained from prepreg in this instance, covers said secondary electrically conductive winding 22 and separates it from a first layer that incorporates a primary conductive winding 12, namely one intended to form at least part of an electrical transformer primary circuit.

On top of this primary conductive winding 12, a thickness of substrate 50, notably obtained from prepreg in this instance, covers said primary electrically conductive winding 12.

The thicknesses of substrate 50 that are obtained from prepreg provide electrical insulation.

The primary 12 and secondary 22 electrically conductive windings notably have a thickness comprised between 0.4 mm and 4 mm, preferably comprised between 0.8 mm and 2 mm.

According to one embodiment, the primary electrically conductive winding 12 may take the form of a planar spiral-shaped winding, depicted for example in FIG. 6. The secondary electrically conductive winding 22 may take the form of a flat electrical conductor, also known as a leadframe, notably having a shape that undulates in the plane of the flat conductor, as illustrated for example in FIG. 7. In particular, the primary electrically conductive winding 12 is formed of an electrical track, notably of a thickness less than or equal to 0.25 mm, and the secondary electrically conductive winding 22 is formed of an electrically conductive leaf of a thickness greater than or equal to 0.4 mm and/or less than or equal to 2 mm.

In a first layer at least, the primary electrically conductive winding 12 here is an electrical track defining two spirals 30 connected in series. These two spirals 30 in the example considered have the same shape and are symmetrical with one another about an axis (X) intersecting the substrate 5. As depicted in FIG. 6, this axis (X) here intersects the series connection 31 between the two spirals 30.

It may also be seen in FIGS. 2 and 3 that, from one end of one spiral 30 to the other, including at the series connection 31 between the two spirals 30, the electrical track defining the primary electrically conductive winding 12 may maintain the same width.

It may also be seen in FIGS. 2, 3 and 6 that each spiral 30 may, at its free end, have a primary connection terminal 32. These primary connection terminals 32 here enable the primary electrically conductive winding 12 to be connected to the high-voltage part of the on-board network. Each primary connection terminal 32 comprises, for example, two studs for distributing the current in the connection with the high-voltage part of the on-board network.

It is seen in FIGS. 2 and 3 that these primary connection terminals 32 here extend on the one same side 33 of the substrate, this side 33 in the example considered being rectilinear.

It may also be seen that, from one spiral 30 to the other, there are the same number of turns, this number of turns here being equal to 5.

In at least a second layer, the secondary electrically conductive winding 22 is, in the examples considered, an electrically conductive leaf of undulating shape.

It may be seen in FIGS. 2, 3 and 5 that, in an axis of stacking perpendicular to the plane of FIGS. 2 and 3 along which the first layer(s) are stacked with the second layer(s), the electrically conductive leaf 22 and the electrical track defining two spirals 30 connected in series partially overlap.

As visible in FIGS. 2, 3 and 7, the electrically conductive leaf may have the shape of a W when viewed along this axis of stacking. This leaf here defines two there-and-back undulations, each there-and-back undulation comprising two straight parts 36 connected to one another by a bent part 37. In this embodiment, the first there-and-back undulation extends between a first secondary connection terminal 38 that connects the secondary electrically conductive winding to the outside, and a second secondary connection terminal 38 that connects this secondary electrically conductive winding to the outside. This connection is, for example, to the low-voltage part of the on-board network. Still in this embodiment, the second there-and-back undulation extends between the second secondary connection terminal 38 and a third secondary connection terminal 38.

It may also be seen in FIGS. 1 to 3 that the secondary connection terminals 38 may project from the one same side 39 of the substrate 5, which side here is rectilinear. This side 39 is the opposite side from the side 33 with respect to which the primary connection terminals 32 project.

It may also be noted in FIG. 2 that each straight part 36 of the electrically conductive leaf is superposed with the straight part of a spiral 30 along the axis of stacking.

According to one embodiment, as for example schematically depicted in FIG. 5, the electrical assembly 10 of the electrical transformer 1 has a stacked structure whereby a succession of second and first layers, or in other words of secondary electrically conductive windings 22 and of primary electrically conductive windings 12, alternate in the mass of the substrate 5.

Thus, with reference to FIG. 5, the electrical assembly comprises, incorporated into the mass of the substrate 5, an alternation of second and first layers. The electrical assembly 10 and a ferromagnetic core 6 added to the electrical assembly 10 form an electrical transformer 1. Each second layer comprises at least a secondary electrically conductive winding part 22 and each first layer comprises at least a primary winding part 12. The primary winding parts 12 together form a primary circuit of the electrical transformer 1. The secondary winding parts 22 together form a secondary circuit of the electrical transformer 1. The second layers are separated from the first layers by a thickness of substrate 50. In particular, as already indicated previously, the substrate 5 is obtained from a prepreg. In particular, the primary winding parts 12 are interconnected with one another by superposition and contact. The secondary winding parts 22 are interconnected with one another by superposition and contact outside of the volume of the substrate 5.

By construction, as a preference, there is no air gap between the first and second layers. As a preference, there is no layer of air in the mass of the substrate 5.

In order to create the planar electrical assembly 10, the method of manufacture described hereinafter is also proposed.

First of all, a first layer comprising a first sheet of prepreg is formed and a primary electrically conductive winding 12 intended to form at least part of the primary circuit of the electrical transformer 1 is etched onto one of the faces of said sheet. A secondary electrically conductive winding 22 is arranged on one prepreg face of the first layer. The secondary electrically conductive winding 22 is intended to form at least part of the secondary circuit of the electrical transformer 1. A second sheet of prepreg is then set down on the secondary electrically conductive winding 22.

In particular, as part of the forming of the first layer of the substrate 5, a primary electrically conductive winding 12 may be etched onto each face of the first sheet of prepreg. A third sheet of prepreg is then set down on one face of the first sheet of prepreg. After that, the secondary electrically conductive winding 22 is set down on the free face of said third sheet of prepreg.

For example, the primary circuit has ten turns formed by the primary electrically conductive winding 12 and the secondary circuit has one turn of secondary conductive winding 122. Of course, the transformation ratio, and therefore the number of turns of the primary electrically conductive windings 12 and secondary electrically conductive windings 22, is adapted to the desired use.

These operations are repeated as necessary in order to form a multilayer substrate base.

The layers of prepreg with the primary electrically conductive windings 12 and secondary electrically conductive windings 22 are pressed together and the temperature is increased. Thus compressed, the electrical assembly 10 forms a PCB incorporating the stack of primary electrically conductive windings 12 and secondary electrically conductive windings 22 which are respectively separated and therefore electrically insulated from one another by a thickness 50 obtained from prepreg. At least one free end of the secondary electrically conductive windings 22 projects from the substrate 5 to create an electrical connection terminal 23 for the secondary circuit.

Note that the material used to create the substrate 5 from material impregnated with epoxy resin (prepreg) is selected from among the materials customarily used for forming PCB substrates. The material selected has a malleability, or in other words a viscosity, suited to the above-described method of manufacture. In particular, it is able to incorporate the primary electrically conductive winding 12 and secondary electrically conductive winding 22 in its face and to completely cover them. In the manufacturing phase, the various layers are pressed against one another such that the material of the substrate 5 becomes insinuated over and between the electrically conductive windings, notably actually within the first or the second layer, so that no layer of air or air cavity remains in the mass of the substrate 5 of the electrical assembly 10.

Once the planar electrical assembly 10 comprising the stack of at least the second layer and the first layer, respectively with at least a primary electrically conductive winding part 12 and at least a secondary electrically conductive winding part 22 has been produced, the ends of the secondary electrically conductive windings that form secondary electrical connectors 23 are brought into contact so as to electrically connect to one another the layers of the stack of secondary electrically conductive windings 22.

This then yields a monolithic planar electrical assembly 10 incorporated into a PCB. In order to produce a complete electrical transformer 1, all that is required is the addition of a ferromagnetic core 6, notably made of ferrite, to said electrical assembly 10. The ferromagnetic core 6 may be a one-piece core or may comprise two or more elements.

The planar electrical assembly 10 offers the advantage, on account of its planar structure, of being easier to cool, namely of easier cooling of the at least one primary electrically conductive winding 12 and of the at least one secondary electrically conductive winding 22. The electrical assembly 10, which is monolithic, may effectively easily be pressed intimately against a heatsink plate 30, notably a fluid-cooled cooling plate, as illustrated for example in FIG. 8. In addition, as it is pressed intimately against a heatsink plate 30, notably a fluid-cooled cooling plate, the planar electrical assembly 10 also allows one face of the core 8 to be pressed intimately against the heatsink plate 30, notably the fluid-cooled cooling plate, so as to cool the core 8.

Furthermore, in the case of a stacked structure of several second layers and several first layers, in which structure the primaries are intercalated between the secondaries, better electromagnetic performance is obtained in comparison with the structures of the prior art.

1. A planar electrical assembly comprising a substrate, in particular formed from sheets of prepreg, and comprising, incorporated into the mass of the substrate:
at least one primary electrically conductive winding, in a first layer of the substrate, and forming at least part of a primary circuit for an electrical transformer, and, on the other hand
at least one secondary electrically conductive winding, in a second layer of the substrate which is superposed on the first layer, and forming at least part of a secondary circuit for the electrical transformer,
the primary electrically conductive winding being formed of an electrical track defining two spirals connected in series, and the secondary electrically conductive winding being formed of an electrically conductive leaf of undulating shape,
in an axis of stacking along which the first layer is stacked with the second layer, the electrically conductive leaf and the electrical track defining two spirals connected in series at least partially overlapping.

2. The planar electrical assembly as claimed in claim 1, the two spirals having the same shape and being symmetrical with one another about an axis intersecting the substrate.

3. The planar electrical assembly as claimed in claim 1, the electrically conductive leaf having the shape of a W when viewed along the axis of stacking.

4. The planar electrical assembly as claimed in claim 3, the electrically conductive leaf defining two there-and-back undulations, each there-and-back undulation comprising two straight parts connected to one another by a bent part.

5. The planar electrical assembly as claimed in claim 4, each straight part of the electrically conductive leaf being superposed with the straight part of a spiral of the electrical track in a first layer along the axis of stacking.

6. The planar electrical assembly as claimed in claim 4, the first there-and-back undulation extending between a first secondary connection terminal that connects the secondary electrically conductive winding to the outside, and a second secondary connection terminal that connects this secondary electrically conductive winding to the outside, and the second there-and-back undulation extending between the second secondary connection terminal and a third secondary connection terminal that connects the secondary electrically conductive winding to the outside.

7. The planar electrical assembly as claimed in claim 3, the primary connection terminals projecting from the one same first side of the substrate and the secondary connection terminals projecting from the one same second side of the substrate, these first and second sides of the substrate being opposite sides.

8. The planar electrical assembly as claimed in claim 1, comprising a plurality of first layers and a plurality of second layers, stacked alternately.

9. The planar electrical assembly as claimed in claim 1, wherein the substrate is obtained from a stack of several sheets of prepreg thermoset together.

10. The planar electrical assembly as claimed in claim 9, wherein:
the first layer of the substrate is obtained from at least a first sheet of prepreg with the at least one primary electrically conductive winding etched onto one of the faces thereof, and
the second layer of the substrate is obtained by adding the at least one secondary electrically conductive winding to a prepreg face of the first layer and by covering said secondary electrically conductive winding with a second sheet of prepreg.

11. The planar electrical assembly as claimed in claim 10, wherein:
the first layer of the substrate is obtained from the first sheet of prepreg with a respective primary electrically conductive winding etched onto each of the faces thereof, a third sheet of prepreg then covering one face of said first sheet of prepreg;
the second layer of substrate is obtained by adding the at least one secondary electrically conductive winding to the free face of the third sheet of prepreg and by covering it with said second sheet of prepreg.

12. The planar electrical assembly as claimed in claim 1, wherein
the electrical track of the primary electrically conductive winding has a thickness less than or equal to 0.25 mm; and
the electrically conductive leaf of the secondary electrically conductive winding has a thickness greater than or equal to 0.4 mm and/or less than 2 mm.

13. An electrical transformer comprising an electrical assembly as claimed in claim 1, as well as a ferromagnetic core added to said substrate so as to magnetically couple the primary electrically conductive windings with the secondary electrically conductive windings.

14. A method for manufacturing an electrical assembly comprising a primary circuit and a secondary circuit, said method comprising the following steps:
a first layer comprising a first sheet of prepreg is formed and a primary electrically conductive winding is etched onto one of the faces of said sheet, said primary electrically conductive winding being intended to form at least part of a primary circuit of an electrical transformer, this primary electrically conductive winding being formed of an electrical track defining two spirals connected in series;
a monolithic electrical conductor, referred to as secondary electrically conductive winding, is sourced, this secondary electrically conductive winding being formed of an electrically conductive leaf having an undulating shape;
the secondary electrically conductive winding is set down on a prepreg face of the first layer, said secondary electrically conductive winding being intended to form at least part of a secondary circuit of the electrical transformer;
a second sheet of prepreg is set down on top;
the entity consisting of the sheets of prepreg and the primary and secondary electrically conductive windings is pressed and heated so as to assemble said sheets together along an axis of stacking and form the electrical assembly comprising the stack of primary and secondary electrically conductive windings and so that, along the axis of stacking, the electrically conductive leaf and the electrical track defining two spirals connected in series at least partially overlap.

15. The method as claimed in claim 14, wherein:
as part of the forming of the first layer of the substrate, a respective primary electrically conductive winding is etched onto the two faces of the first sheet of prepreg
then a third sheet of prepreg is set down on one face of the first sheet of prepreg after which the secondary electrically conductive winding is set down on the free face of said third sheet of prepreg.

16. The method as claimed in claim 14, wherein a ferromagnetic core is added to the substrate so as to magnetically couple the primary electrically conductive windings with the secondary electrically conductive windings and form an electrical transformer.

17. The planar electrical assembly as claimed in claim 2, the electrically conductive leaf having the shape of a W when viewed along the axis of stacking.

18. The planar electrical assembly as claimed in claim 5, the first there-and-back undulation extending between a first secondary connection terminal that connects the secondary electrically conductive winding to the outside, and a second secondary connection terminal that connects this secondary electrically conductive winding to the outside, and the second there-and-back undulation extending between the second secondary connection terminal and a third secondary connection terminal that connects the secondary electrically conductive winding to the outside.

19. The planar electrical assembly as claimed in claim 6, the primary connection terminals projecting from the one same first side of the substrate and the secondary connection terminals projecting from the one same second side of the substrate, these first and second sides of the substrate being opposite sides.

20. The planar electrical assembly as claimed in claim 2, comprising a plurality of first layers and a plurality of second layers, stacked alternately.
